(19) United States
(12) Patent Application Publication
(10) Pub. No.: US 2026/0226571 A1
(43) Pub. Date: Aug. 6, 2026

(54) A METHOD TO PRODUCE PRESS HARDENED PARTS AT HIGH PRODUCTIVITY

(71) Applicant: ArcelorMittal, Luxembourg (LU)

(72) Inventors: Laurent CRETTEUR, GOUVIEUX (FR); Antoine JOUMEL, SENLIS (FR)

(21) Appl. No.: 19/147,745

(22) PCT Filed: Jan. 19, 2024
(86) PCT No.: PCT/IB2024/050523

§ 371 Date: Jul. 14, 2025

(30) Foreign Application Priority Data
Jan. 30, 2023 (WO) PCT/IB2023/050781

(51) Int. Cl. C21D 1/673; B23K 11/11; C21D 9/46; C22C 38/02; C22C 38/04; C22C 38/06; C22C 38/28; C22C 38/32

(52) U.S. Cl. CPC C21D 1/673; B23K 11/11; C21D 9/46; C22C 38/02; C22C 38/04; C22C 38/06; C22C 38/28; C22C 38/32

(57) ABSTRACT

A press hardening method including the following steps: A) providing a coated steel sheet, the total thickness of a polymerized coating layer on the coated steel sheet being from 3.0 to 10.0 μm, B) trimming or cutting the coated steel sheet 5 into a blank, C) heating the blank at a temperature from 850 to 950° C. and during 2.00 to 3.40 minutes if the steel sheet is thicker than 0.6 mm and thinner or equal to 1.5 mm, and during 2.50 to 4.00 minutes if the steel sheet is thicker than 1.5 mm and thinner than 3.0 mm, D) transferring the hot blank into a press tool, E) forming and press hardening of the part.

The present invention relates to press hardening of steel sheets at a high productivity rate. The invention is particularly well suited for the manufacture of automotive vehicles.

### BACKGROUND

In recent years the use of coated steels in hot stamping and press-hardening processes to manufacture parts has become important, especially in the automotive industry. Fabrication of such parts may include the following main steps:
Coating of a steel sheet by hot dipping in a metallic bath,
Trimming or cutting said sheet into a blank,
Heating said blank to obtain the complete transformation of the steel microstructure into austenite,
Transferring said hot blank into a press tool,
Forming and press hardening of the part.

### SUMMARY OF THE INVENTION

It is known from the prior art to apply a paint layer on the blank, so that the emissivity of its surface is modified. Thus, the time during which the steel sheet must be heated is reduced, and the productivity increased.

It is also known that the surface after press hardening is critical for later processing of the part, like welding or final painting, the first layer of which is applied by cataphoresis.

The patent EP3126459 discloses an aluminized steel sheet overlaid on at least a part of the above-mentioned pre-coating by a polymerized coating layer 3 having a thickness between 2 μm and 30 μm composed of a polymer that does not contain silicon, and the nitrogen content of which is greater than 1% by weight expressed in relation to the above-mentioned layer, wherein the above-mentioned polymerized coating layer contains carbon pigments in a quantity between 3 and 30% by weight, expressed in relation to above-mentioned layer.

However, this patent makes no link between the thickness of the polymerized coating layer and the reduction of the heating time. Furthermore, the patent is silent about other properties impacted by the paint thickness from 2 to 30 μm.

It is also known to use a local reinforcement named patch. The patch is spot-welded to a main blank before austenitization heat-treatment and press hardening. This way, a part with a locally thicker region is achieved. The patch can be made of the same material as the main blank, so that the thickness is doubled where the patch is welded. The resulting blank is a patched blank.

The patch is heated and press-formed together with the main blank on which it has been previously welded. The forming operation occurs on one single stamping tool. This way of integrating the reinforcement to the blank allows to reduce the manufacturing costs compared to a reinforcement welded after forming.

The present invention aims at reducing the paint thickness for cost reasons, while limiting neither the increase of productivity nor the spot-welding properties of the painted steel sheet. The present invention also ensures that the surface after press-hardening is compatible with the later processing of the part, like welding or final painting.

The present invention provides a press hardening method comprising the following steps:
A) Providing a coated steel sheet (5), made of a metallic coated steel sheet (4), said metallic coated steel sheet comprising a steel sheet for heat treatment (1), coated with a metallic coating (2), wherein said metallic coated steel sheet is overlaid, over at least a portion of said metallic coating, by a polymerized coating layer (3) on a first side of said metallic coated steel sheet, the second side of said metallic coated steel sheet being optionally overlaid, over at least a portion of said metallic coating, by a polymerized coating layer (3), the total thickness of said polymerized coating layer on said coated steel sheet (5) being from 3.0 to 10.0 μm composed of a polymer that does not contain silicon and the nitrogen content of which is less than 1 weight % expressed in relation to said polymerized coating layer, said polymerized coating layer containing carbon pigments in a quantity from 3 to 30 weight %, expressed in relation to said polymerized coating layer,
B) Trimming or cutting said coated steel sheet (5) into a blank,
C) Heating said blank in a furnace at a temperature set from 850 to 950° C. and during 2.00 to 3.40 minutes if the thickest portion of said blank is thicker than 0.6 mm and thinner or equal to 1.5 mm, and during 2.50 to 4.50 minutes if the thickest portion of said blank is thicker than 1.5 mm and thinner than 3.0 mm,
D) Transferring said hot blank into a press tool, and
E) Forming said hot blank into a part and press hardening said part into a press-hardened part.

The present invention also provides a vehicle comprising at least one press-hardened part obtained by the method as described above.

### BRIEF DESCRIPTION OF THE DRAWINGS

Additional characteristics and advantages of the invention will become apparent in the following description with reference to the accompanying drawings, in which:

FIG. 1 illustrates a schematic example of metallic coated sheet or blank according to the invention, before heating and press hardening.

FIG. 2 illustrates a spot-welding equipment to carry out an embodiment of the present invention.

### DETAILED DESCRIPTION

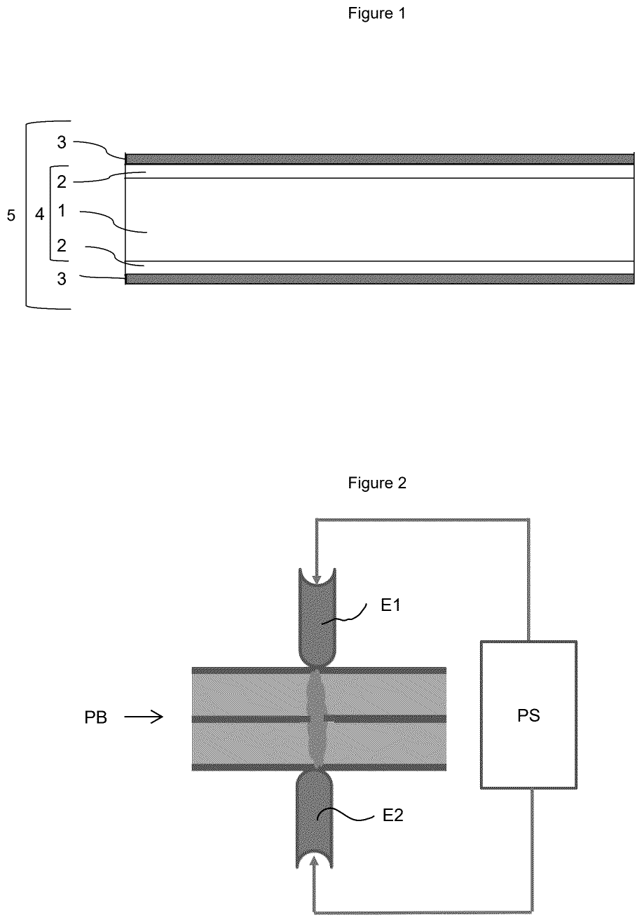

An object of the invention is achieved by a method comprising the following steps:
A) Providing a coated steel sheet 5 (as shown in FIG. 1), made of a metallic coated steel sheet 4, said metallic coated steel sheet comprising a steel sheet for heat treatment 1, coated with a metallic coating 2, wherein said metallic coated steel sheet is overlaid, over at least a portion of said metallic coating, by a polymerized coating layer 3 on a first side of said metallic coated steel sheet, the second side of said metallic coated steel sheet being optionally overlaid, over at least a portion of said metallic coating, by a polymerized coating layer 3, the total thickness of said polymerized coating layer on said coated steel sheet 5 being from 3.0 to 10.0 μm composed of a polymer that does not contain silicon and the nitrogen content of which is less than 1 weight % expressed in relation to said polymerized coating layer, said polymerized coating layer containing carbon pigments in a quantity from 3 to 30 weight %, expressed in relation to said polymerized coating layer,
B) Trimming or cutting said coated steel sheet 5 into a blank,
C) Heating said blank in a furnace at a temperature set from 850 to 950° C. and during 2.00 to 3.40 minutes if the thickest portion of said blank is thicker than 0.6 mm and thinner or equal to 1.5 mm, and during 2.50 to 4.50 minutes if the thickest portion of said blank is thicker than 1.5 mm and thinner than 3.0 mm,
D) Transferring said hot blank into a press tool,
E) Forming said hot blank into a part and press hardening said part into a press-hardened part.

The steel sheet used in the present invention in step A is made of steel for heat treatment as described in the European Standard EN 10083. It can have a tensile resistance superior to 500 MPa, advantageously between 500 and 2000 MPa before or after heat-treatment.

The weight composition of steel sheet is preferably as follows: 0.03%≤C≤0.50%; 0.3%≤Mn≤3.0%; 0.05%≤Si≤0.8%; 0.015%≤Ti≤0.2%; 0.005%≤Al≤0.1%; 0%≤Cr≤2.50%; 0%≤S≤0.05%; 0%≤P≤0.1%; 0%≤B≤0.010%; 0%≤Ni≤2.5%; 0%≤Mo≤0.7%; 0%≤Nb≤0.15%; 0%≤N≤0.015%; 0%≤Cu≤0.15%; 0%≤Ca≤0.01%; 0%≤W≤0.35%, the balance being iron and unavoidable impurities from the manufacture of steel.

For example, the steel sheet is 22MnB5 with the following weight composition: 0.20%≤C≤0.25%; 0.15%≤Si≤0.35%; 1.10%≤Mn≤1.40%; 0%≤Cr≤0.30%; 0.020%≤Ti≤0.060%; 0.020%≤Al≤0.060%; 0.002%≤B≤0.004%, the remainder being iron and unavoidable impurities from the manufacture of steel.

In another embodiment, the steel sheet has the following weight composition: 0.24%≤C≤0.38%; 0.40%≤Mn≤3%; 0.10%≤Si≤0.70%; 0.015%≤Al≤0.070%; Cr≤2%; 0.25%≤Ni≤2%; 0.015%≤Ti≤0.10%; Nb≤0.060%; 0.0005%≤B≤0.0040%; the remainder being iron and unavoidable impurities resulting from the manufacture of steel.

Alternatively, the steel sheet can have the following weight composition: 0.30%≤C≤0.40%; 0.5%≤Mn≤1.0%; 0.40%≤Si≤0.80%; 0.1%≤Cr≤0.4%; 0.1%≤Mo≤0.5%; 0.01%≤Nb≤0.1%; 0.01%≤Al≤0.1%; 0.008%≤Ti≤0.003%; 0.0005%≤B≤0.003%; 0.0%≤P≤0.02%; 0.0%≤Ca≤0.001%; 0.0%≤S≤0.004%; 0.0%≤N≤0.005%, the remainder being iron and unavoidable impurities resulting from the manufacture of steel.

In another embodiment, the steel sheet has the following weight composition: 0.040%≤C≤0.100%; 0.80%≤Mn≤2.00%; 0%≤Si≤0.30%; 0%≤S≤0.005%; 0%≤P≤0.030%; 0.010%≤Al≤0.070%; 0.015%≤Nb≤0.100%; 0.030%≤Ti≤0.080%; 0%≤N≤0.009%; 0%≤Cu≤0.100%; 0%≤Ni≤0.100%; 0%≤Cr≤0.100%; 0%≤Mo≤0.100%, the balance being iron and unavoidable impurities from the manufacture of steel.

In another embodiment, the steel sheet has the following weight composition: 0.06%≤C≤0.1%, 1%≤Mn≤2%, Si≤0.5%, Al≤0.1%, 0.02%≤Cr≤0.1%, 0.02%≤Nb≤0.1%, 0.0003%≤B≤0.01%, N≤0.01%, S≤0.003%, P≤0.020% less than 0.1% of Cu, Ni and Mo, the remainder being iron and unavoidable impurities resulting from the manufacture of steel.

In another embodiment, the steel sheet has the following weight composition: 0.015%≤C≤0.25%; 0.5%≤Mn≤1.8%; 0.1%≤Si≤1.25%; 0.01%≤Al≤0.1%; 0.1%≤Cr≤1.0%; 0.01%≤Ti≤0.1%; 0%≤S≤0.01%; 0.001%≤B≤0.004%; 0%≤P≤0.020%; 0%≤N≤0.01%; the balance being iron and unavoidable impurities from the manufacture of steel.

Alternatively, the steel sheet has the following weight composition: 0.2%≤C≤0.34%; 0.5%≤Mn≤1.24%; 0.5%≤Si≤2.0%; 0%≤S≤0.01%; 0%≤P≤0.020%; 0%≤N≤0.01%, the balance being iron and unavoidable impurities from the manufacture of steel.

The steel sheet according to the invention can be obtained by hot rolling and optionally cold rolling depending on the desired thickness, which can be for example from 0.6 to 3.0 mm, preferably from 0.7 to 2.0 mm, or even 1.0 to 1.5 mm.

The steel sheet used in the invention can also have undergone a flexible rolling step. Flexible rolling is characterized in that the gap between the work rolls is deliberately changed during the rolling operation. The object of flexible rolling, which is also named tailor rolling, is to produce a rolled sheet with a load- and weight-optimized cross section. In this case, the steel sheet used in the present invention features a thickness varying along the rolling direction. Said thickness being inherited from the rolling rate can vary from 1 to 50%.

The steel sheet used in the invention can be metallic coated by hot dip in a bath. When the metallic coating 2 is applied by hot dip coating, iron comes from the dissolution of the steel sheet in the hot dip coating bath and can vary during production.

In a preferred embodiment, the bath is based on zinc and comprises more than 50% by weight of zinc. The temperature of the bath is then set from 450 to 550° C.

In another preferred embodiment, the bath is based on aluminum and comprises more than 50% by weight of aluminum. The temperature of the bath is then set from 600 to 700° C., preferably from 620 to 650° C.

In a preferred embodiment, the metallic coating comprises, by weight, up to 15% silicon, up to 5% iron, the balance being aluminum and unavoidable impurities.

The coating weight is set during the wiping process by gas knives in a range from 50 to 500 g/m², preferably from 80 to 150 g/m².

On the metallic coating 2, the metallic coated steel sheet according to the invention is overlaid, over at least a portion of said metallic coating, by a polymerized coating layer 3 on a first side of said metallic coated steel sheet, the second side of said metallic coated steel sheet being optionally overlaid, over at least a portion of said metallic coating, by a polymerized coating layer 3, the total thickness of said polymerized coating layer on said steel sheet being from 3.0 to 10.0 μm.

In step B), the coated steel sheet 5 is cut or trimmed into a blank

According to the invention, the heating time of the blank in the furnace needed to completely transform the steel microstructure into austenite is reduced compared to the prior art.

The blank is heated in step C) at a temperature set from 850 to 950° C., preferably from 900 to 950° C.

Once the blank has reached the furnace temperature, it is known that one additional minute in the furnace is sufficient to completely transform its microstructure into austenite.

According to the invention, the heating time to reach a complete transformation into austenite is from 2.00 to 3.40 minutes if the thickest portion of the blank is thicker than 0.6 mm and thinner or equal to 1.5 mm, and from 2.50 to 4.50 minutes if the thickest portion of the blank is thicker than 1.5 mm and thinner than 3.0 mm,

The inventors have found that a thickness of less than 3.0 μm polymerized coating layer in total for both faces brings an insufficient heating time reduction compared to the prior art. The resulting productivity increase is limited and not worth the cost of the polymerized coating layer.

Surprisingly, the inventors have found that a thickness of more than 10.0 μm polymerized coating layer in total for both sides brings no or very little reduction of the heating time. It is believed that the emissivity of the polymerized coating layer doesn't evolve above 10 μm thickness.

While investigating the patched blank embodiment of the invention, the inventors have found that polymerized two steel sheets couldn't be spot welded with each other if the polymerized thickness at the is above 7.0 μm. This welding property is mandatory for patched blank applications.

The ability to spot-welding is usually estimated by the welding range. The welding range is the difference between the maximum current at which no splashing occurs and the minimum current ensuring the minimum required nugget size. Automotive manufacturers consider a welding range of less than 1.0 kA as insufficient for the welding process.

Any polymerized coating layer at the interface between two steel sheets usually acts as an electrical insulator. However, the inventors have found that the polymerized coating layer according to the invention is weldable with the following restriction: Above a thickness of 7.0 μm, it prevents electrical current to flow from one steel sheet to the other. The weld nugget can't be formed, and electric arcs occur when applying electric current.

According to the invention, the welding range is 1.0 kA or above, and an electric arc occurs for less than 15% of the welds.

The polymerized coating layer is composed of a polymer that does not contain silicon and the nitrogen content of which is less than 1% by weight expressed in relation to the layer, wherein the polymerized coating layer contains carbon pigments in a quantity between 3 and 30% by weight, expressed in relation to the layer.

The polymerized coating layer doesn't comprise elements selected from Zn, Zr or Ti, nor their oxides, which are ordinary components of paints. The presence of such elements in the polymerized coating layer would lead to the fact that those oxides would remain on the surface of the press hardened part and may prevent the later processing of the part, like welding or implementation of cataphoresis.

Preferably, the elements of the polymer are selected from a list consisting of C, H, O, N.

In a preferred embodiment, the polymerized coating layer is obtained from a resin in the form of a dispersion or an emulsion in aqueous phase.

According to another preferred embodiment, the polymerized coating layer is obtained from a resin in the form of solution in a non-aqueous solvent.

In another preferred embodiment, the polymerized coating layer consists of a film that is roll bonded to the metallic coating.

Preferably, the polymerized coating layer is obtained from an acrylic type resin.

In a preferred embodiment, the polymerized coating layer is obtained from an epoxy or acrylic type resin in the form of solution in a non-aqueous solvent.

In another preferred embodiment, the polymerized coating layer consists of a polyethylene terephthalate or polyethylene or polybutylene-terephthalate or polypropylene film.

The nitrogen content of the polymerized coating layer 3 must be limited to 1%, preferably 0.5%, and very preferably 0.2%, under penalty of forming compounds of the HCN type or excessive quantities of ammonia during heating to the temperature necessary for stamping.

The content by weight of carbon pigments, expressed in relation to the polymerized coating layer 3, is between 3 and 30%. Below 3%, the reduction of the heating time is insufficient. Above 30%, the mixture has a viscosity unsuitable for application.

The carbon pigments can be in the form of activated carbon, like graphite for example.

Activated carbon can, for example, be obtained by carbonization of carbon-containing material like coke or biomass. It can also be obtained by impregnation with appropriate chemical compounds.

The pigments are constituted preferably at least partly of activated carbon.

In a preferred embodiment, the pigments are constituted at least partly of graphite.

The content by weight of activated carbon, expressed in relation to the deposited layer, must be less than 5% to be suitable for mixing with the polymer.

In step E), the blank is deformed at a temperature from 600 to 800° C. The cooling rate is then controlled depending on the steel composition, in such a way that the final microstructure after the hot forming comprises mostly martensite.

The invention will now be illustrated by examples. They are not limiting.

### Example 1: Influence of Polymer Thickness on Several Steel Sheet Thicknesses

Steel sheets having a thickness of 1.0, 1.4, 1.5, 1.6, 1.8 and 2.0 mm were provided. They are made of steel having the following composition in percent by weight: 0.22 wt. % of carbon, 1.2 wt. % of manganese, 0.25 wt. % of silicon, 0.2 wt. % of chromium, 0.04 wt. % of aluminum, 0.04 wt. % of titanium and 0.003 wt. % of boron, the balance being iron and impurities resulting from the manufacturing process.

These steel sheets were hot-dip coated with a metallic coating of 24 μm per face. Said metallic coating comprises, by weight, 9% of silicon, 3% of iron, the balance being aluminum and unavoidable impurities.

These metallic coated steel sheets were cut to 100×150 mm² samples.

A polymer layer was then deposited by roll coating over the entirety of one face, the opposite face being left unpainted, i. e. with metallic coating only. Several applications were performed so that the paint thickness tested evolves from 2.2 to 7.7 μm. The polymer layer is composed of acrylic phenoxy resin containing less than 0.2% nitrogen, and the dry extract of the paint contains 12 to 15% by weight of graphite carbon pigments. The layers deposited were dried by passing through a furnace at 70° C. for 5 minutes.

The weight of the polymerized coating layer is measured on a square sample of 10 cm×10 cm. The sample is weighed on lab scale of manufacturer METTLER, type AE200, before and after dissolution of the polymer with ethyl acetate as a solvent. The thickness is computed from the weight with the density of the dry extract of the paint.

Samples prepared under the conditions indicated above were equipped with thermocouples. They were then introduced in a furnace with ordinary atmosphere, the temperature of which was set to 915° C. They were heated from the ambient temperature to 915° C., then held at this temperature for one minute and eventually removed from the furnace and left under ambient air for cooling. The heating causes an alloying of the coating with the iron of the steel sheet, as well as a complete phase transformation of the steel microstructure into austenite.

Thermocouples were used to measure the duration of heating from the ambient temperature to the furnace temperature. This duration plus one minute,

$$Δ {t}_{20}^{915} + 1 min ,$$

is the time needed to obtain a proper alloying of the coating and a complete austenitization of the blank.

The reference is an unpainted sample. The heating time reduction for a sample covered by a thickness th of paint, is noted H % and expressed as follows:

$$H \% = 100 * ( \frac{Δ {t}_{20 , REF}^{915} - Δ {t}_{20 , t h}^{915}}{Δ {t}_{20 , R E F}^{915} + 1} )$$

The results are presented in Table 1.

TABLE 1
Paint on one single side

| | | Polymerized | | |
|---|---|---|---|---|
| | Steel | coating | | |
| | sheet | layer | Heating time in | |
| | thickness | thickness | the furnace | H % |
| Trial Nr | mm | μm | minutes | % |
| 1 | 1.0 | 0.0 | 3.27 | 0 |
| 2* | 1.0 | 5.2 | 2.25 | 31 |
| 3* | 1.0 | 6.3 | 2.21 | 32 |
| 4 | 1.5 | 0.0 | 4.38 | 0 |
| 5 | 1.5 | 2.2 | 3.44 | 26 |
| 6* | 1.5 | 5.1 | 2.91 | 34 |
| 7 | 1.6 | 0.0 | 4.62 | 0 |
| 8* | 1.6 | 4.1 | 2.99 | 35 |
| 9* | 1.6 | 6.3 | 2.89 | 37 |
| 10 | 1.8 | 0.0 | 4.92 | 0 |
| 11* | 1.8 | 4.4 | 3.46 | 30 |
| 12* | 1.8 | 4.6 | 3.39 | 31 |
| 13 | 2.0 | 0.0 | 5.25 | 0 |
| 14* | 2.0 | 4.1 | 3.68 | 30 |
| 15* | 2.0 | 5.6 | 3.57 | 32 |

*trials according to the invention
Underlined values are not according to the invention.

Trials 5, not according to the invention, with a single-sided polymerized coating layer thickness of less than 3.0 μm show less than 30% heating time reduction.

The same experiment was performed with polymer on both faces.

TABLE 2
Polymer on both sides

| | Steel | | | | Heating time | |
|---|---|---|---|---|---|---|
| | sheet | Polymerized coating layer | | | in the | |
| Trial | thickness | thickness (μm) | | | furnace | H % |
| Nr | mm | Face 1 | Face 2 | Total | minutes | % |
| 16 | 1.4 | 0.0 | 0.0 | 0.0 | 3.80 | 0 |
| 17* | 1.4 | 3.4 | 5.5 | 8.9 | 2.35 | 38 |
| 18 | 1.5 | 0.0 | 0.0 | 0.0 | 4.63 | 0 |
| 19* | 1.5 | 2.1 | 2.3 | 4.4 | 2.97 | 36 |
| 20* | 1.5 | 2.0 | 3.2 | 5.2 | 2.77 | 40 |
| 21* | 1.5 | 2.1 | 4.3 | 6.4 | 2.71 | 41 |
| 22* | 1.5 | 2.2 | 5.1 | 7.3 | 2.62 | 43 |
| 23* | 1.5 | 2.7 | 6.6 | 9.3 | 2.57 | 44 |
| 24 | 1.8 | 0.0 | 0.0 | 0.0 | 4.92 | 0 |
| 25* | 1.8 | 3.3 | 6.1 | 9.4 | 2.75 | 44 |

*trials according to the invention
Underlined values are not according to the invention.

Trials 17, 19 to 23 and 25 according to the invention show more than 35% and up to 44% heating time reduction.

Trials 19 to 21 have from 2.0 to 2.1 μm thickness of the polymerized coating layer on face 1. Despite this low thickness of the polymerized coating layer on one side, they show a sufficient heating time reduction thanks to a total polymerized coating layer of more than 3.0 μm, according to the invention.

### Example 2: Spot-Welding

Several samples of the same steel grade coated with the same metallic coating were selected and different polymerized coating layer thicknesses were applied on them. Then these were tested on a welding machine to determine the welding range.

The spot-welding machine comprises a pair of welding electrodes E1, E2 and a spot-welding electric power source PS is used, as illustrated schematically in FIG. 2. The electrodes permit the joining of two steel sheets, for example to create a patched blank PB. The current is mid frequency direct current (MFDC) obtained by conversion of AC current supply. The electrodes have a diameter of 6.0 mm, the welding force is 4.5 kN, the welding time is 380 ms followed by a holding time of 260 ms.

The welding range is the difference between the maximum current at which no splashing occurs and the minimal current ensuring the minimum required nugget size.

The welding test starts at 4 kA and the current is increased by steps of 0.4 kA, two spot welds being made for each current level. When both welds show expulsion at the faying interface, the current is decreased by steps of 0.2 kA. When there is no splashing, a second spot weld is performed without changing current. Imax is achieved when two consecutive welds have no splashing occurrence at the same current level. For searching Imin, one starts from the spot welds performed during the first current increase sequence. Imin is obtained when 2 spot welds at the same intensity satisfy to the minimal size requirement of 4√t.

The welding range is calculated as (Imax-Imin). According to the invention, it must be 1 kA or more.

Electric arcs, occurring when current can't flow through the sheets, may happen because the paint layer acts as an electrical insulator. Electric arcs are recognizable with a lightning flash and a slamming sound. According to the invention, an electric arc occurs for less than 15% of the welds.

TABLE 3
Spot welding test

| | Steel | Polymerized coating layer | | | | |
|---|---|---|---|---|---|---|
| | sheet | thickness (μm) | | | welding | electric arc |
| Trial | thickness | upper | lower | | range | occurrence |
| Nr | mm | sample | sample | interface | kA | % |
| 26* | 1.5 | 2.2 | 2.3 | 4.5 | 1.2 | 0 |
| 27* | 1.5 | 2.6 | 3.1 | 5.7 | 1.7 | 0 |
| 28* | 1.5 | 2.2 | 4.7 | 6.9 | 1.2 | 11 |
| 29 | 1.5 | 3.8 | 4.4 | 8.2 | 0.2 | 38 |
| 30 | 1.5 | 4.5 | 4.9 | 9.4 | 0.2 | 33 |
| 31 | 1.5 | 5.3 | 5.3 | 10.6 | 0.0 | 41 |
| 32 | 1.5 | 7.2 | 7.5 | 14.7 | 0.0 | 80 |

*trials according to the invention
Underlined values are not according to the invention.

Trials 29 to 32 not according to the invention with more than 7.0 μm polymerized coating layer thickness at the interface between the two coated steel sheets are not weldable.

What is claimed is:

1-17. (canceled)

18. A press hardening method comprising the following steps:
A) providing a coated steel sheet, made of a metallic coated steel sheet, the metallic coated steel sheet having a steel sheet for heat treatment, coated with a metallic coating, wherein the metallic coated steel sheet is overlaid, over at least a portion of the metallic coating, by a polymerized coating layer on a first side of the metallic coated steel sheet, a total thickness of the polymerized coating layer on the coated steel sheet being from 3.0 to 10.0 μm composed of a polymer not containing silicon and having a nitrogen content of less than 1 weight % expressed in relation to the polymerized coating layer, the polymerized coating layer containing carbon pigments in a quantity from 3 to 30 weight %, expressed in relation to the polymerized coating layer;
B) trimming or cutting the coated steel sheet into a blank;
C) heating the blank in a furnace at a temperature set from 850 to 950° C. and for 2.00 to 3.40 minutes when a thickest portion of the blank is thicker than 0.6 mm and thinner or equal to 1.5 mm, and for 2.50 to 4.50 minutes when the thickest portion of said blank is thicker than 1.5 mm and thinner than 3.0 mm;
D) transferring the heated blank into a press tool; and
E) forming the heated blank into a part and press hardening the part into a press-hardened part.

19. The method as recited in claim 18 wherein the blank processed in steps C) to E) is a patched blank, and wherein the following steps are introduced after step B) and before step C):
B1) providing the coated steel sheet of step A) or another coated steel sheet according to step A);
B2) trimming or cutting the coated steel sheet or the other coated steel sheet into a patch;
B3) stacking the patch on top of the blank obtained in step B), wherein the total polymerized coating layer at the interface between the patch and the blank is below 7.0 μm; and
B4) spot-welding the blank and the patch together via electric current though a pair of electrodes to obtain a patched blank.

20. The method as recited in claim 18 wherein in step C) the heating temperature is set from 900 to 950° C.

21. The method as recited in claim 18 wherein in step A) elements of the polymer are selected from a list consisting of C, H, O, N.

22. The method as recited in claim 18 wherein in step A) the polymerized coating layer is obtained from a resin in the form of a dispersion or emulsion in an aqueous phase.

23. The method as recited in claim 22 wherein in step A), the polymerized coating layer is obtained from an acrylic resin.

24. The method as recited in claim 18 wherein in step A) the polymerized coating layer is obtained from a resin in the form of solution in a non-aqueous solvent.

25. The method as recited in claim 24 wherein in step A) the polymerized coating layer is obtained from an epoxy or acrylic resin.

26. The method as recited in claim 18 wherein in step A) the polymerized coating layer is constituted by a film roll-bonded to the metallic coating.

27. The method as recited in claim 26 wherein the film is made of polyethylene-terephthalate or polyethylene or polybutylene-terephthalate or polypropylene.

28. The method as recited in claim 18 wherein in step A) the pigments are constituted at least partly by activated carbon.

29. The method as recited in claim 18 wherein in step A) the pigments are constituted at least partly by graphite.

30. The method as recited in claim 18 wherein in step A) a quantity of activated carbon in the polymerized coating layer is less than 5% by weight in relation to the layer.

31. The method as recited in claim 18 wherein in step A) the metallic coating is based on aluminum.

32. The method as recited in claim 18 wherein in step A) the metallic coating comprises, by weight, up to 15% silicon, up to 5% iron, a balance being aluminum and unavoidable impurities

33. The method as recited in claim 18 wherein in step A) the metallic coating is based on zinc

34. The method as recited in claim 18 wherein a second side of the metallic coated steel sheet is overlaid, over at least a portion of the metallic coating, by a second polymerized coating layer.

35. A vehicle comprising at least one press-hardened part obtained by the method as recited in claim 18.
